(19) United States
(12) Patent Application Publication
(10) Pub. No.: US 2017/0109244 A1
(43) Pub. Date: Apr. 20, 2017

(54) STORAGE DEVICE AND METHOD

(71) Applicant: Kabushiki Kaisha Toshiba, Tokyo (JP)

(72) Inventors: Yuu Kawai, Yokohama Kanagawa (JP); Mamoru Mori, Kawasaki Kanagawa (JP)

(21) Appl. No.: 15/013,502

(22) Filed: Feb. 2, 2016

Related U.S. Application Data
(60) Provisional application No. 62/242,126, filed on Oct. 15, 2015.

(51) Int. Cl. G06F 11/16; G06F 11/30; G06F 13/42; G06F 11/07

(52) U.S. Cl. CPC G06F 11/1625; G06F 11/0727; G06F 11/3034; G06F 11/0757; G06F 11/3041; G06F 13/4282

(57) ABSTRACT

According to one embodiment, a storage device connectable to a host and includes a storage medium and a controller. The controller is configured to measure, if detecting a situation in which quality of a signal is measurable in a state where communication with a host is possible, an eye pattern of the signal communicated with the host, and store a measurement result on the storage medium.

### CROSS-REFERENCE TO RELATED APPLICATIONS

This application claims the benefit of U.S. Provisional Application No. 62/242,126, filed Oct. 15, 2015, the entire contents of which are incorporated herein by reference.

### FIELD

Embodiments described herein relate generally to a storage device and a storage method.

### BACKGROUND

Even storage devices (which may be called devices hereinafter) conforming to interface standards, a quality of a signal exchanged with a host may deteriorate, resulting in communication failure.

As a general scheme for monitoring the quality of an interface signal, there is an eye opening monitor (EOM) scheme. In the EOM mode, an eye pattern (which may be also called eye diagram or eye opening) of a signal is measured with an oscilloscope, to determine signal quality based on the waveform thereof. However, if EOM is performed during actual communication, a device cannot exclude from receiving signals those which are not measurement objects. Signals suitable for measurement are all the signals which are exchanged at frequencies specified with the interface, and unsuitable signals are the rest of the signals. For example, in a case of the interface of Serial Advanced Technology Attachment (SATA) standard, out-of-band (OOB) signaling is performed for establishing communication. But, signals such as COMRESET and COMWAKE used in this signaling are those of a stage before starting the exchange of signals at the communication frequency of the SATA standard and at frequencies of a zone different from that of the communication frequency of the SATA standard. Therefore, such signals are not suitable for EOM. Further, in the non-signal state called a DC idle state, the EOM cannot be performed.

Furthermore, since there have been in recent years hosts such as those of data centers, which require maintenance of confidentiality, these hosts cannot be checked out for inspection of the hard disk drive, and therefore in many cases, interface signals cannot be measured while the host and the device are actually communicating.

For this reason, an operational mode of a host and a device, is shifted from a normal communication mode where signals unsuitable for the EOM may be present, to a test mode where only signals suitable for EOM are present and the signals unsuitable for the EOM are not present, and then the EOM is performed. But, in measurement in the test mode, it is not possible to analyze interface-related problems, which occurs only in a state of the normal communication actually being communicated between the host and the device (which refer to problems based on a communication affinity between the host and the device, for example, those occurring when a signal quality of the host is poor, or only when a detailed conditions of both sides of the host and the device meet each other). For example, there is a problem which occurs in a special situation such as a return from the power save mode of the SATA interface. Such a special situation cannot be covered by the test mode. Various factors exist for degrading the quality of signals, such as poor signal quality on the host side, the detailed conditions of both sides of the host and the device, meeting each other. Therefore, a cause of poor communication quality cannot be precisely analyzed as long as the quality of signals actually being exchanged is not measured.

The hard disk drive is known as an example of the storage device, but the storage device is not limited to this. For example, the storage device may be, for example, a solid-state drive or a hybrid drive, and the above-provided description is applicable to the storage devices in general.

SATA is described above as an example of the interface of a storage device, but the interface is not limited to this. The interface may be SAS, SCSI, IDE, PATA or the like, and the above-provided description is applicable to the interfaces of storage devices in general.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an exemplary structure of a hard disk drive.

FIG. 2 shows an example of an eye pattern generated by EOM.

FIG. 3 is a waveform chart showing an example of the general COB sequence.

FIG. 4 is a waveform chart showing an example of the OOB sequence by which EOM of an embodiment is carried out.

FIG. 5 is a flowchart showing an example the flow of the EOM.

### DETAILED DESCRIPTION

Various embodiments will be described hereinafter with reference to the accompanying drawings.

In general, according to one embodiment, a storage device connectable to a host includes a storage medium, and a controller. The controller is configured to measure, if detection of a situation in which signal quality is measurable in a state where communication with the host is possible, an eye pattern of a signal communicated with the host, and store a measurement result on the storage medium.

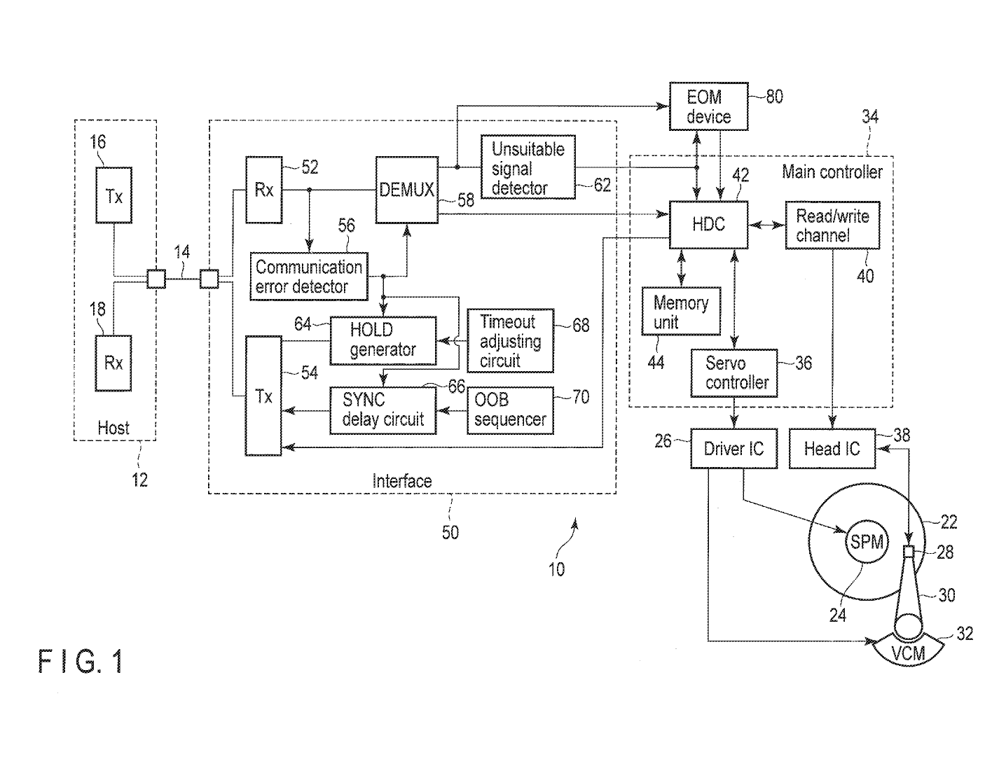

FIG. 1 is a typical block diagram showing a structure of a hard disk drive, which is an embodiment of a storage device.

A hard disk drive (HDD) 10 and a host 12 are connected by a SATA cable 14. In the HDD 10, a disk 22 is rotated at high speed by a spindle motor (SPM) 24. The spindle motor 24 is driven by current (or voltage) supplied from a driver IC 26.

A head 28 is mounted on a distal end of an arm 30, to be disposed to face the disk 22. The arm 30 is driven by a voice coil motor (VCM) 32 and thus the head 28 is moved in the radial direction of the disk 22 to seek a target position. The voice coil motor 32 is controlled by a drive current or drive voltage from the driver IC 26.

FIG. 1 illustrates a hard disk drive having a single disk. 22, but two or more disks may be arranged to stack in layers.

The driver IC 26 is configured to drive the spindle motor 24 and the voice coil motor 32 under a control of a servo controller 36 in a main controller 34.

A head IC 38 is also called a head amplifier and amplifies an output signal of a read element of the head. 28. The head IC 38 converts write data output from the main controller 34 (to be more precise, a read/write channel 40 in the main controller 34) into a write current, and outputs the write current to a write element of the head 28.

The main controller 34 is realized by a system LSI on which a plurality of elements are integrated on a single chip. The main controller 34 includes the read/write (R/W) channel 40, a hard disk controller (HDC) 42, the servo controller 36 and a memory unit 44. The memory unit 44 includes a flash memory and a RAM. The flash memory is a rewritable nonvolatile semiconductor memory, and in a part of the storage area, stored in advance are a control program (firmware) to realize functions of the main controller 34 containing the HDC 42 and the servo controller 36 and a control program to inspect the quality of interface signals. At least a part of the storage area of the RAM is used as a work area for the HDC 42 and the servo controller 36. The memory unit 44 may be integrated in another chip separate from that of the main controller 34.

The read/write channel 40 is configured to process signals related to read/write with respect to the disk 22. For example, the read/write channel 40 decodes the output of the read element of the head 28 amplified by the head IC38. The read/write channel 40 extracts servo data from the output signal of the read element, and supplies the data to the servo controller 36. The read/write channel 40 codes the write data transmitted from the HDC 42, and transmits the coded write data to the head 1038.

The HDC 42 is connected to the host 12 via an interface 50. The host 12 uses the HDD 10 as its own storage device. The HDC 42 functions also as an interface controller configured to transmit signals to the host 12 and also receive signals transmitted from the host 12.

The servo controller 36 controls the spindle motor 24 and the voice coil motor 32 via the driver IC 26. In order to position the head 28 to the target position of the target track on the disk 22, the servo controller 36 controls the voice coil motor 32 based on the servo data extracted by the read/write channel 40. The controlling of the voice coil motor 32 is equivalent to the controlling of the arm. 30 including the voice coil motor 32.

The HDC 42 and the servo controller 36 each includes a microprocessor unit (MPU) (not shown). The MPUs execute respective control programs for the HDC 42 and the servo controller 36 and thus realize the functions as the HDC 42 and the servo controller 36, respectively. These control programs are stored in a flash memory of the memory unit 44. A single MPU may execute these control programs by time sharing.

The interface 50 contains a receiver (Rx) 52 connected to a transmitter (Tx) 16 of the host 12 and a transmitter (Tx) 54 connected to a receiver (Rx) 18 of the host 12. The signals received with the receiver 52 are supplied to a communication error detector 56 and a demultiplexer (or selector) 58. The communication error detector 56 is configured to detect an error in a received signal. The errors to be detected by the detector 56 are CRC errors which indicate that the error correction of received data has not been successful and errors in which a control signal cannot be recognized. As will be described later, in SATA, data are subjected to 8-to-10-bit conversion in a link layer, to allocate character patterns determined to be not used in normal data pattern conversion, to control character strings (primitives). For this reason, if the waveform of an interface signal deteriorates, such an error that a primitive cannot be recognized may occur, which is also called a 10-bit error. The output of the communication error detector 56 is supplied to the demultiplexer 58 and a HOLD generator 64, which will be described later.

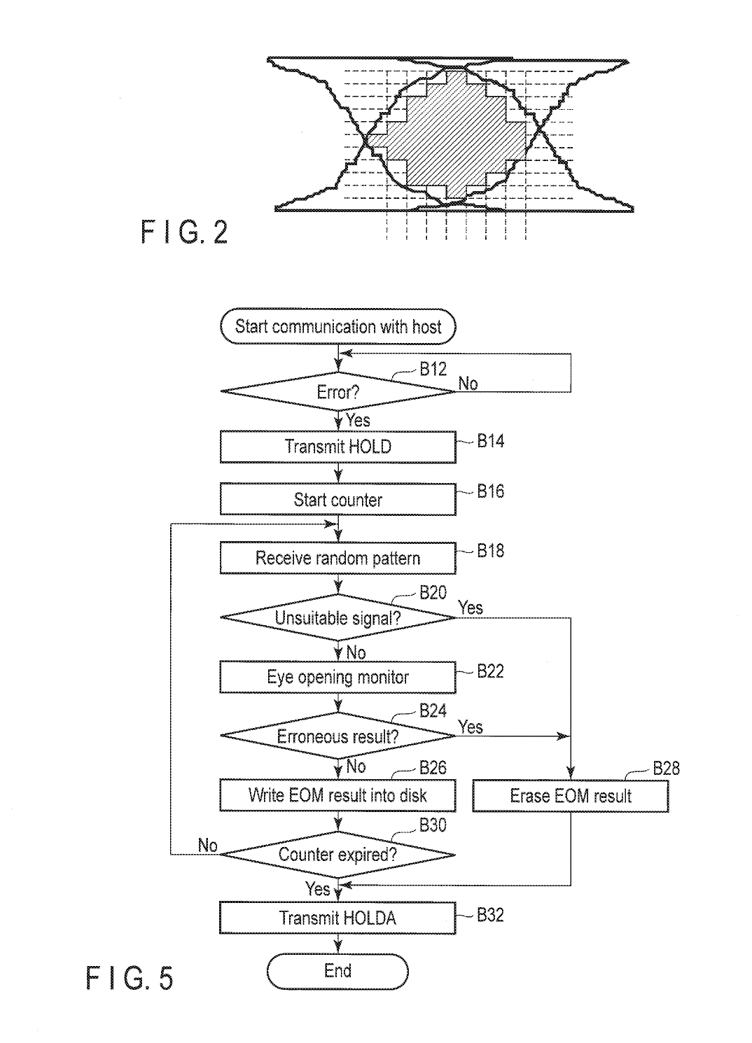

The demultiplexer 58 is configured to output the signal input from the receiver 52 from a first or second output terminal based on the output of the communication error detector 56. The signal output from the first output terminal of the demultiplexer 58 is supplied to an unsuitable signal detector 62 and an CON device 80, whereas the signal output from the second output terminal of the demultiplexer 58 is supplied to the write channel of the R/W channel 40 via the HDC 42. The unsuitable signal detector 62 is configured to determine whether a received signal of the receiver 52 is suitable for EOM. That is, the signals exchanged at the frequency of the SATA standard are suitable for EOM, whereas the other signals, for example, signals such as COMRESET and COMWAKE used by the OOB signaling are at a frequency different from the communication frequency of the SATA standard and are not suitable for EOM. Further, a signal-free state called a DC idle state is also not suitable for EOM. The output of the unsuitable signal detector 62 is supplied to the EOM device 80 and the HDC 42. The EON device 80 includes an oscilloscope and observes a signal a plurality of times for each point while changing the delay and threshold and generates eye patterns by aligning the points. An example of the eye patterns is shown in FIG. 2. The vertical axis is for the voltage and the horizontal axis is for the time. The form of the eye pattern is normal when the ratio between vertical and horizontal dimensions is 1 to 1 in a predetermined display range. When the waveform of a received signal deteriorates, one of the height and width will become small. Thus, based on the form of the eye pattern, it is possible to detect the degradation in quality of communication of signals. The measurement result is supplied to the HDC 42. When the detection result indicative of an unsuitable signal is supplied from the unsuitable signal detector 62, the EOM device 80 terminates EOM.

The HDC 42 is configured to supply the received signal supplied from the MUX 58 and the measurement result supplied from the EOM device 80 to the write channel and control each component to write these signals on the disk 22. When the unsuitable signal detector 62 detects an unsuitable signal, the HDC 42 terminals the writing of the measurement result to the disk 22 and controls each component to erase the measurement result of the current measurement session. The output data of the disk 22 reproduced by the read channel is transmitted to the host 12 from the transmitter 51 via the HDC 42. The HOLD generator 64 generates a HOLD, which is a primitive of the link layer, and the output thereof is also transmitted to the host 12 from the transmitter 54. The output timing of the HOLD generator 64 is controlled by the output of the communication error detector 56 and the output of a timeout adjusting circuit 68.

The interface 50 includes an OOB sequencer 70 configured to generate an OOB signal, and SYNC issued from the OOB sequencer 70 is transmitted to the host 12 from the transmitter 54 via a SYNC delay circuit 66. The delay time of the SYNC delay circuit 66 is controlled by the output of the communication error detector 56.

An outline of SATA will be described before describing the operation of the embodiment. SATA has a layered structure including, from the host side, a transport layer, a link layer and a physical layer. The physical layer is connected to a device. When a host transmits data, data required for command transmission is generated in the transport layer, the data is coded in the link layer and finally, the data is transmitted by the physical layer. The interface 50 shown in FIG. 1 is the physical layer.

The physical layer serializes the data from the link layer and transmits the serialized data to a device or converts received data from the device into a form which can be interpreted by the link layer, then hands it over to the link layer. The physical layer also generates and detects an OOB signal used for synchronization when starting the power or recovering the communication on the occurrence of a communication failure.

The link layer controls the physical layer and codes data. The transport layer issues a command to control the entire protocol.

A command is used to control the protocol of the transport layer. The command is executed by transmission and reception of data row called frame instruction structure (FIS). The FIS includes SOF, contents, CRC and EOF. SOF and EOF are special control character strings called primitives, which indicate the lead and tail of the FIS, respectively. The description of a FIS is in unit of 4-byte and a 4-byte unit is a double word (Dword).

An example of the command protocol is COMRESET, which is a software reset to reset a device compulsorily from a host and used for protocol errors or the like. The software reset is finished by the signal from the device after the sequence is completed.

The link layer performs an 8-to-10-bit conversion, and also controls primitives and adds CRC to ELS. Since the clock signal is not prepared in SATA, the Embedded Clocking mode, in which clocks are embedded in transmission signals, is adopted and the clocks are extracted based on the variation of a signal. If the state where a signal is at the same level (1 or 0) continues, it is not possible to extract a clock, making it impossible to synchronize the signal. Here, by converting 8-bit data into a 10-bit code which contains an edge moderately, a code now contains an edge, which makes it possible to extract a clock. That is, in 8-to-10-bit conversion, continuation of the same signal state is restricted. Since the data for 8 bits is described by 10 bits, the amount of describable data can be increased. Therefore, character patterns not used in a normal data pattern conversion are allocated to the primitives. Examples of the primitives of the link layer are indicated in TABLE 1.

TABLE 1

| Primitive | Name | Description |
|---|---|---|
| ALIGN | Physical | Upon receipt of an ALIGN, the physical layer readjusts internal operations |
| | layer control | as necessary to perform its functions correctly. This primitive is always |
| | | sent in pairs - there is no condition where an odd number of ALIGN primitives |
| | | shall be sent (except for retimed loopback) |
| CONT | Continue repeating | The CONT primitive allows long strings of repeated primitives to be eliminated. |
| | previous primitive | The CONT primitive implies that the previously received primitive be repeated |
| | | as long as another primitive is not received. |
| EOF | End of frame | EOF marks the end of a frame. |
| | | The previous non-primitive Dword is the CRC for the frame. |
| HOLD | Hold data | HOLD is transmitted in place of payload data within a frame when the |
| | transmission | transmitter does not have the next payload data ready for transmission. |
| | | HOLD is also transmitted on the backchannel when a receiver is not ready |
| | | to receive additional payload data. |
| HOLDA | Hold acknowledge | This primitive is sent by a transmitter as long the HOLD primitive is |
| | | received by its companion receiver. |
| PMACK | Power management | Sent in response to a PMREQ_S or PMREQ_P when a receiving node is |
| | acknowledge | prepared to enter a power mode state. |
| PMNAK | Power management | Sent in response to a PMREQ_S or PMREQ_P when a receiving node is not |
| | denial | prepared to enter a power mode state or when power management is not supported. |
| PMRES_P | Power management | This primitive is sent continuously until PMACK or PMNAK is received. |
| | request | When PMACK is received, current node (host or device) will stop PMREQ_P |
| | to partial | and enters the Partial power management state. |
| PMRES_S | Power management | This primitive is sent continuously until PMACK or PMNAK is received. |
| | request | When PMACK is received, current node (host or device) will stop PMREQ_S |
| | to Slumber | and enters the Slumber power management state. |
| SOF | Start of frame | Start of a frame. Payload and CRC follow to EOF. |
| SYNC | Synchronization | Synchronizing primitive always idle. |

In SATA, while nothing is operating, two Align primitives are output every 256 Dwords for synchronization. For saving the power for this operation, a power save mode is defined. If a host instructs to shift to the power save mode, the host transmits PMREQ_S or PMREQ_P to a device. Then, if the device can shift to the power save mode, the device replies PMACK to the host. Then, the host and the device shift to a power save mode. If the host instructs the return to the normal power save mode from the power save mode, the host transmits COMWAKE to the device. Then, when the device is ready for the return, the device replies COMWAKE to the host. After that, the host and the device return to the normal power mode.

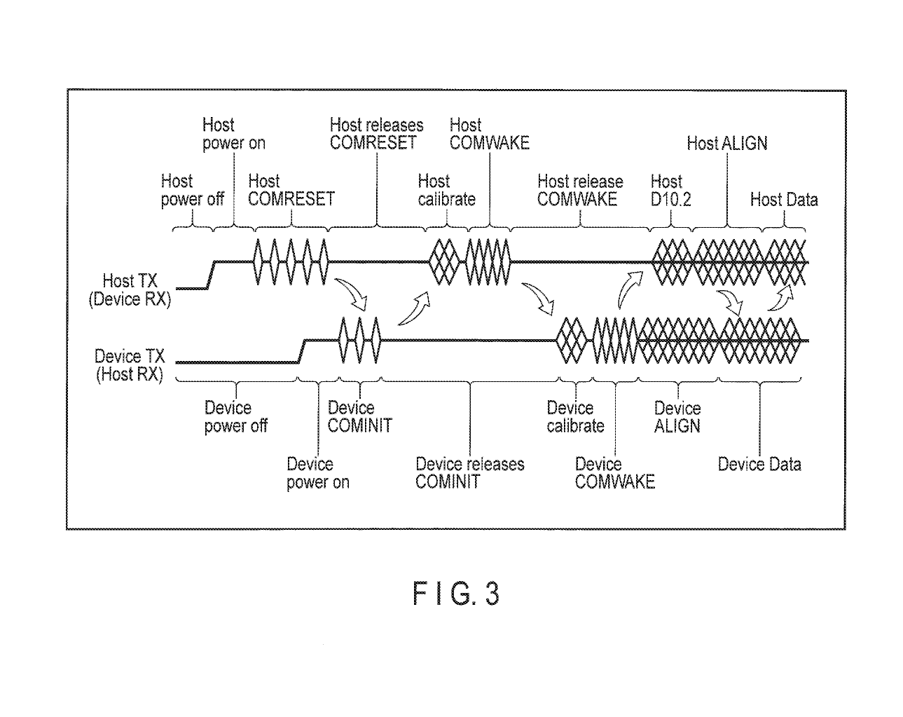

With reference to FIG. 3, the OOB signaling of the physical layer to control speed negotiation, reset the interface, initialize, establish communication, and control speed negotiation will be described. Signals transmitted by a host (signals received by a device) are illustrated in an upper half of FIG. 3, whereas those transmitted from the device (received by the host) are illustrated in a lower half thereof.

From the state were the powers of a host and a device are off, when the power of the host is turned on, the host issues COMRESET. Then, when the power of the device is turned on and detects COMREST, the device issues COMINIT. COMRESET and COMINIT each include six continuous burst signals with a fixed interval, having frequencies other than those specified by SATA. Here, these commands are detected as to whether the width of each burst signal is a predetermined width and the interval between two burst signals is a predetermined interval.

If COMINIT is detected, the host performs calibration, issues a calibration signal and issues COMWAKE after that. If COMWAKE is detected, the device performs a calibration, issues a calibration signal and issues COMWAKE after that. After issue of COMWAKE, the device returns from the power save mode to the normal power mode.

As COMRESET and COMINIT, COMWAKE includes six continuous burst signals with a fixed interval, having frequencies other than those specified by SATA. Here, the command is detected as to whether the width of each burst signal is a predetermined width and the interval between two burst signals is a predetermined interval. The burst width of each of COMRESET, COMINIT and COMWAKE is 106.7 ns. The burst interval of each of COMRESET and COMINIT is 320 ns and the burst interval of COMWAKE is 106.7 ns.

If COMWAKE from the device is detected, the host returns from the power save mode to the normal power mode.

If communication is established by detecting COMRESET, COMINIT and COMWAKE, the host and the device exchange ALIGN and perform negotiation for the transmission speed. There are three transmission speeds defined. The negotiation starts from the lowest transmission speed, and the transmission speed is gradually increased. When the transmission speed is determined, the host and the device start data transmission. Although not shown, SYNC is transmitted before the data transmission.

Next, the outline of EOM in the embodiment will be described.

In the embodiment, EOM is not carried out in the test more where only signals suitable for EOM are output, but signals not suitable for EOM are not present, but carried out in a normal communicate mode where signals unsuitable for EOM may be present. That is, in the state where communication with a host is possible, if a device monitors a communication with the host and detects that it is in an EOM-enabled state, EOM is performed. Then, the measurement result is stored on the disk 22.

Thus, without shifting to the test mode, the EOM can be performed during normal communication and therefore the interface problem, which actually occurs only during communication between a host and a device, can also be analyzed. Since the measurement result is stored in the storage, it is not necessary to perform one entire EOM continuously, but by performing short-time EOMs a number of times, the same effect as the case of carrying out one entire long EOM can be obtained.

If an abnormal value is included in a measurement result, EOM is terminated, the measurement result is discarded, or if data unsuitable for EOM is received, EOM is terminated and the measurement result is discarded.

For storing measurement results, it is not necessarily to store all the measurement results, but only specific measurement results may be stored to save the measurement time/data volume.

Next, details of EOM of the embodiment will be given.

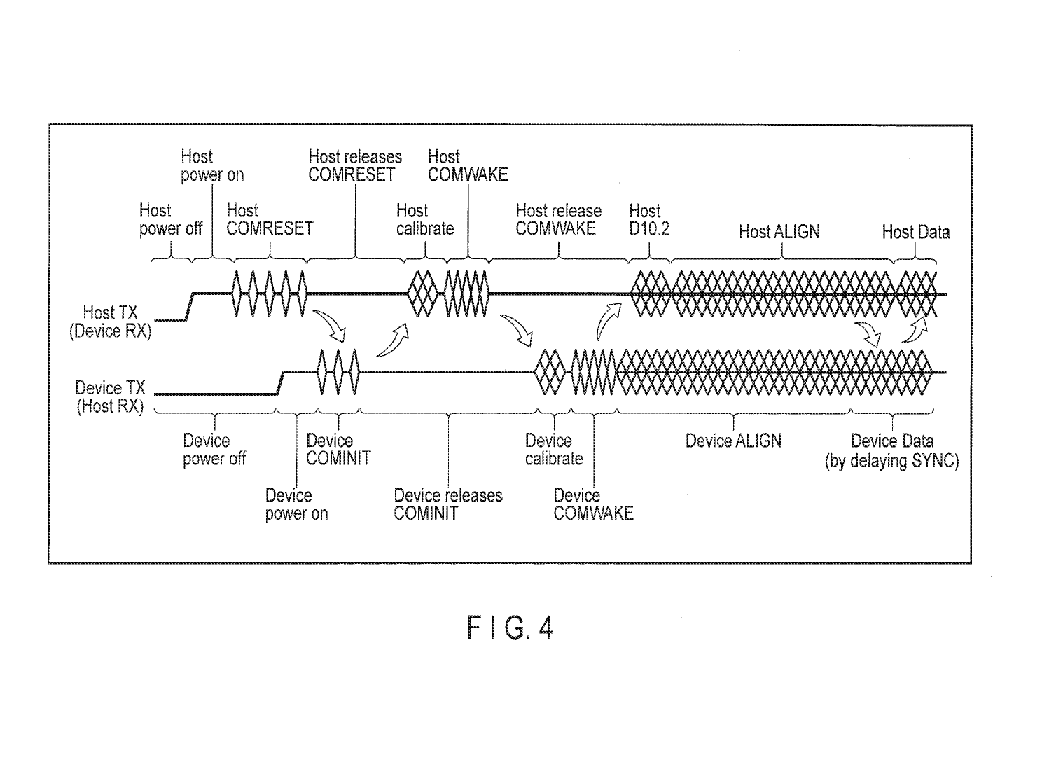

When returning to the normal mode from the power save mode in a normal OOB sequence (FIG. 3), a host and a device exchange ALIGN and perform speed negotiation, and thereafter data transmission is started. But, this sequence is partially changed, and as shown in FIG. 4, after the speed negotiation, the device delays the start of the data transmission by a predetermined period. More specifically, the transmission of SYNC issued from the OOB sequencer 70 before the data transmission is delayed by the predetermined period by the delay circuit 66. During this period, the device can perform. EOM. Although not shown in FIG. 4, the host may extend the transmission of ALIGN by a predetermined period. During this period, the device can perform EOM. While returning to the normal mode from the power save mode, signals are likely to fall into an unstable state easily, and therefore it is significant to perform EOM during this period.

Next, after the end of the OOB sequence shown in FIG. 4, if a communication with a host is started, a device execute the process shown in FIG. 5.

In block B12, it is determined whether or not the communication error detector 56 has detected a communication error. If a CRC error or a 10-bit error has been detected by the communication error detector 56, the HOLD generator 64 generates HOLD in block B14. In block B16, the counter of the timeout adjusting circuit 68 is started. The counter is configured to be completed upon timeout of the host. If HOLD is received, the host 12 is set in a waiting state, issues CONT and transmits a random pattern to the device. In block B18, the device receives the random pattern.

In block B20, it is determined whether or not the unsuitable signal detector 62 has detected an unsuitable signal. The unsuitable signal detector 62 is configured to determine whether or not a signal received by the receiver 52 is unsuitable for EOM. The basis of this is that signals communicated at the frequencies of the SATA standard are suitable for EOM, but other signals, for example, signals such as COMRESET and COMWAKE, used by the OOB signaling are of frequencies different from the communication frequencies of the SATA standard and are not suitable for EOM. Further, the signal-free state called a DC idle state is not suitable for EOM. If the unsuitable signal detector 62 detects an unsuitable signal, block B28 is executed and all the measurement results of the current EOM measurement are discarded (erased from the disk 22).

When no unsuitable signal is detected, EOM is performed in block 522, and measurement results including the shape of an eye pattern, a value and the like are obtained. When receiving the measurement result, the HDC 42 determines whether or not an erroneous value is contained in the measurement result in block B24. When an erroneous value is contained, block B28 is executed and all the measurement results of the current EOM measurement are discarded (erased from the disk 22).

If no erroneous value is contained, the measurement results are stored on the disk 22 in block B26. Here, it is not necessary to store all the measurement results in consideration of the storage capacity, write-in time, etc. For example, by setting the minimum specification value of height of the eye pattern as a threshold, only the number of times that the eye height is less than the threshold during a measurement may be stored. Or, measurement results may be classified by conditions to start EOM (such as at the time of the return from the power save mode in OOB and at the time of detection of a communication error in actual communication), and stored on the disk 22.

In block B30, it is determined whether the counter of the timeout adjusting circuit 68 is completed. If it is not, the process returns to block B18 and the steps from the reception of a random pattern are repeated.

When the counter is completed or after the results of an EOM are erased in block B28, the HOLD generator 64 stops generating HOLD and generates HOLDA in place in block B32. Thereafter, the host 22 returns to the state enabling communication with the device 10.

According to the embodiment, while returning to the normal mode from the power save mode, the host continues transmitting ALIGN, and therefore during this period, the device can perform EOM. Similarly, after performing the speed negotiation, the transmission timing of SYNC is delayed, and during this period, the device can perform EOM. Thus, the cause for the deterioration of signal waveform, which may occur while returning to the normal mode, which signals easily fall into an unstable state, can be clarified.

If EOM is performed during communication, the transfer speed of SATA may be affected. But, according to the embodiment, EOM is performed when a communication error occurs as shown in FIG. 5. Therefore, the cause of the communication error can be ascertained without affecting the transfer rate. In this manner, even for devices connected to a host required to maintain confidentiality and prohibited to be taken out for a test, such as a data center, it is possible to analyze the signal quality of communication with a host.

Further, if a signal unsuitable for EOM is detected or a measurement result indicates an abnormal value in the middle of EOM, EOM is stopped and the measurement result is discarded. Therefore, it is possible to avoid to continue useless measurements and to perform analysis based on an unreliable measurement result. Furthermore, if the storage capacity and memory time are restricted, all the measurement results (raw data) are stored, but only specific measurement results or data of less volume obtained by converting the raw data of a measurement result, for example, the number of times that the eye height of an eye pattern becomes less than a threshold, may be stored.

In the case of an interface including two or more ports in the physical layer, such as SAS, all the ports are not always operating, but there is a time in which at least one port is in an idle state. During this time period, dummy communication may be performed by using the port in the idle state to perform EOM. It is sufficient for the dummy communication to mirror the communication via the port actually being used for communication.

As an embodiment of the storage device, a hard disk drive is described. Note that the storage device is not limited to this, but the examples thereof include a solid-state drive, a hybrid drive and the like. In fact, the embodiment can be applied to storage devices in general.

As an example of an interface for a storage device, SATA is described. Note that the interface is not limited, to this, but the examples thereof include SAS, SCSI, IDE, PATA and the like. In fact, the embodiment can be applied to interfaces for storage devices in general.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device connectable to a host, the device comprising:
a storage medium; and
a controller configured to measure, if detection of a situation in which signal quality is measurable in a state where communication with the host is possible, an eye pattern of a signal communicated with the host, and store a measurement result on the storage medium.

2. The storage device of claim 1, wherein
the controller is further configured to measure the eye pattern if a communication error with the host is detected.

3. The storage device of claim 1, wherein
the storage device is connected to the host according to SATA interface; and
the controller is further configured to measure the eye pattern if an error-correction processing error or a primitive reception error is detected or if COMRESET is received at a time other than a time of a reception schedule.

4. The storage device of claim 3, wherein
the controller is further configured to transmit HOLD to the host if the error-correction processing error or the primitive reception error is detected or if the COMRESET is received at the time other than the time of the reception schedule, set the host into a standby state, and measure the eye pattern.

5. The storage device of claim 1, wherein
the storage device is connected to the host according to SATA interface; and
the controller is further configured to delay transmission of SYNC which should be transmitted after receiving ALIGN from the host during out-of-band signaling with the host, and measure the eye pattern during delay.

6. The storage device of claim 1, wherein
the controller is further configured to measure the eye pattern in divisions in a number of times.

7. The storage device of claim 1, wherein
the controller further comprises a timeout counter configured to detect timeout of a communication with the host, and
wherein an eye pattern measuring time corresponds to a time of the timeout.

8. The storage device of claim. 1, wherein
the controller is further configured to stop measuring the eye pattern if the measurement result is abnormal, and discard the measurement result stored in the storage medium.

9. The storage device of claim 1, wherein
the controller is further configured to stop measuring the eye pattern if a signal unsuitable for the measurement is received, and discard the measurement result stored in the storage medium.

10. The storage device of claim 9, wherein
the storage device is connected to the host according to SATA interface; and
the controller is further configured to stop measuring the eye pattern if COMRESET is received or a DC Idle state starts.

11. The storage device of claim 1, wherein
the controller is further configured to store only measurement results fulfilling a predetermined condition on the storage medium.

12. The storage device of claim 11, wherein
the controller is further configured to store the number of times that a value of the measurement result exceeds a threshold, on the storage medium.

13. The storage device of claim 11, wherein
the controller is further configured to classify measurement results by each factor for a situation in which quality of a signal is not measurable, to be stored on the storage medium.

14. A method for a storage device connectable to a host, the method comprising:
measuring, if detection of a situation in which signal quality is measurable in a state where communication with the host is possible, an eye pattern of a signal exchange with the host; and
storing a measurement result on a storage medium.

15. The method of claim 14, wherein
the measuring comprises measuring the eye pattern if a communication error with the host is detected.

16. The method of claim 14, wherein
the measuring comprises measuring the eye pattern in divisions in a number of times.

17. The method of claim 14, further comprising:
stopping measuring the eye pattern if the measurement result is abnormal; and
discarding the measurement result stored in the storage medium.

18. The method of claim 14, further comprising:
stopping measuring the eye pattern if a signal unsuitable for the measurement is received; and
discarding the measurement result stored in the storage medium.

19. The method of claim. 14, wherein
the storing comprises storing only measurement results fulfilling a predetermined condition on the storage medium.

20. The method of claim 14, wherein the storing comprises classifying measurement results by each factor for a situation in which quality of a signal is not measurable, to be stored on the storage medium.
